(19) United States
(12) Patent Application Publication
(10) Pub. No.: US 2006/0157442 A1
(43) Pub. Date: Jul. 20, 2006

(54) Method and apparatus for forming surface shape, method and apparatus for forming flying surface shape of magnetic head

(75) Inventors: Yoshiaki Ito, Shatin (HK); Takeshi Nakada, Shatin (HK); Kunihiro Ueda, Shatin (HK)

Correspondence Address: GREENBLUM & BERNSTEIN, P.L.C., 1950 ROLAND CLARKE PLACE, RESTON, VA, 20191, US

(73) Assignee: SAE Magnetics (H.K.) Ltd., of Hong Kong

(21) Appl. No.: 11/326,474

(22) Filed: Jan. 6, 2006

(30) Foreign Application Priority Data
Jan. 18, 2005 (JP) 2005-9944

(51) Int. Cl. B44C 1/22; C23F 1/00

(52) U.S. Cl. 216/22; 156/345.31

(57) ABSTRACT

To form a surface shape of an etching object in a short time at low cost, and to make the surface shape to be formed highly accurate. An apparatus for forming a surface shape includes a resist forming device for forming a resist of a predetermined shape on a predetermined surface of the etching object, and an etching device for performing etching to the predetermined surface of the etching object on which the resist is formed. The resist forming device includes a resist attaching device for attaching a resist material to a predetermined surface of the etching object, and a laser irradiating device for irradiating a laser beam to the attached resist material so as to remove a part thereof to a thereby shape it into a predetermined shape.

### BACKGROUND OF THE INVENTION

1. Field of the Invention

The present invention relates to a method and an apparatus for forming a surface shape, and in particular, to a method and an apparatus for forming a surface shape by forming a resist and performing etching.

2. Related Art

A magnetic disk drive (HDD) is provided with a magnetic head in which a magnetic head element part for reading and writing data with respect to a magnetic disk is formed. In a recent magnetic disk drive, as data to be recorded becomes denser, there are increasing demands for lowering the flying height in order to make the magnetic head close to the magnetic disk surface as much as possible.

In order to realize such a low flying height, on the air bearing surface of a magnetic head, an irregular pattern of a predetermined shape is formed so as to generate an appropriate dynamic pressure with an air flow flown in when the magnetic disk is rotated. The shape of the air bearing surface becomes more complex in recent years, so in the forming method thereof, it is indispensable to perform etching in multiple stages (multiple cycles).

For example, Patent Document 1 (publication of Japanese Patent Application Laid-open No. 10-228617) discloses a typical method of forming an air bearing surface of a magnetic head. The method will be explained with reference to FIG. 10. First, to a bar-shaped wafer on which a plurality of magnetic head structural bodies are aligned in a line, predetermined lapping processing is performed, and then a resist of a predetermined pattern is applied (step S101). Next, cure processing is performed (step S102), and exposure (step S103) and development are performed (step S104). Then, dry etching is performed (step S105). Through the five steps described above, one level difference is formed. In order to form more level differences, after the applied resist is removed (negative determinations in step S106 and step S107), steps S101 to S105 are repeated. Thereby, it is possible to form an air bearing surface having multiple level differences and complex irregularities.

However, in the method of forming an air bearing surface of a magnetic head in the conventional example described above, an applied resist is exposed and developed, so it is difficult to form an extremely complex shape. This causes a problem that it is difficult to cope with forming an air bearing surface of a magnetic head which becomes or will become more complex in recent years or in the future.

Further, when forming each level difference, exposure and development are performed to each applied resist each time, so the number of steps for forming an air bearing surface tends to increase further. This causes a problem that the manufacturing time and the manufacturing cost of a magnetic head increase. Along with it, exposure and development are required for forming a resist each time, whereby the alignment thereof is troublesome. This causes a problem that the accuracy in the shape of the air bearing surface to be formed is degraded, and the manufacturing time further increases.

Moreover, a large number of reticles (masks) of a predetermined pattern must be prepared, which may lead to a problem of an increase in the manufacturing cost. Further, in exposure, if the resist is thicker comparing with the focus depth of the imaging surface, the end face of the resist after development cannot be formed sharply, whereby the wall angle of the irregularities defined by etching cannot be formed steeply. Accordingly, there is also caused a problem that it is difficult to stabilize the flying height in such a magnetic head slider.

### SUMMARY OF THE INVENTION

It is therefore an object of the present invention to form a surface shape of an etching object in a short time at low cost, and to make the surface shape to be formed highly accurate.

In view of the above, a method of forming a surface shape, which is an embodiment of the present invention, comprises: a resist forming step in which a resist of a predetermined shape is formed on a predetermined surface of an etching object; and an etching step in which etching is performed to the predetermined surface of the etching object on which the resist is formed. The resist forming step includes: a resist attaching step in which a resist material is attached to the predetermined surface of the etching object; and a shaping step in which a laser beam is irradiated to the resist material attached so as to remove a part of the resist material to thereby shape the resist material into the predetermined shape.

The shaping step is characterized in that the resist material is thermally decomposed and removed by the laser beam. For example, in the shaping step, the resist material is sublimated and removed by the laser beam. At this time, it is desirable that the resists material be a material having resistance to etching and capable of being thermally decomposed or sublimated.

According to the invention described above, first, on a predetermined surface of the etching object, a resist material is attached on a wide range containing all or a part of the shape to be formed by applying processing or the like. Then, a laser beam is irradiated to the part stuck out of the predetermined shape to be formed so as to remove the part. Thereby, the resist can be shaped into the predetermined shape. Then, by performing etching, a dented part is formed in the part not covered with the resist, whereby level difference is formed on the predetermined surface of the etching object.

Thereby, a resist of the predetermined shape can be shaped by using a laser beam that positioning of the irradiating position can be performed with high accuracy, so it is possible to form a surface shape with higher accuracy. Along with it, a conventional step in which exposure and development are performed to a resist applied to the predetermined surface when forming the resist is not required any more, so it is possible to shorten the steps of forming the surface shape. Further, by repeating the steps described above, complex irregularities can be formed with high accuracy. Further, since exposure and development are not required any more as described above, reticles are not needed, which leads to a cost reduction. Further, although highly accurate positioning is required for exposure and development when etching is performed repeatedly, such processing is not required, so it is possible to further shorten the steps of forming.

In particular, by using the aforementioned method of forming an air bearing surface of a magnetic head, it is possible to form an air bearing surface having fine and complex irregularities with high accuracy. At this time, since the resist can be formed to be thin, the end face of the resist can be formed sharply, so the wall angle of the irregularities defined by etching can be made steeper. Thereby, it is possible to stabilize the flying height of the magnetic head, and to improve the reliability of reading and writing of data performed by using the magnetic head.

Further, the method of forming the surface shape comprises, following the etching step, shaping step and etching step. At this time, in the shaping step after the etching step is characterized in that the resist used for the etching in the etching step performed just before is shaped to be in another predetermined shape.

In this way, by performing the shaping step by irradiating a laser beam so as to remove a part of the resist which has been formed on a predetermined surface of the etching object and has been used for etching once, it is possible to form a new resist shape. Accordingly, the number of times that the resist is removed and the number of time that a new resist is attached can be reduced, whereby the resist can be utilized effectively. As a result, it is possible to reduce the cost and the processing time.

Further, the resist attaching step is characterized in that the resist material is attached to the predetermined surface of the etching object by being discharged thereto. For example, the resist material is discharged by an inkjet system or a bubble jet system. Thereby, the resist can be attached corresponding to the predetermined shape to be formed with higher accuracy before the shaping step, whereby it is possible to perform shaping by irradiating a laser beam later easily with high accuracy.

Further, an apparatus for forming a surface shape, which is another aspect of the present invention comprises: a resist forming device for forming a resist of a predetermined shape on a predetermined surface of an etching object; and an etching device for performing etching to the predetermined surface of the etching object on which the resist is formed. The resist forming device includes: a resist attaching device for attaching a resist material to the predetermined surface of the etching object; and a laser irradiating device for irradiating a laser beam to the resist material attached so as to remove a part of the resist material to thereby shape the resist material into the predetermined shape.

The laser irradiating device is characterized as to thermally decompose and remove the resist material by the laser beam. For example, the laser irradiating device sublimates and removes the resist material by the laser beam. At this time, the resists material to be attached to the etching object by the resist attaching device is a material having resistance to etching and capable of being thermally decomposed or sublimated.

Further, the apparatus comprises a control device for controlling the operation of the laser irradiating device. The control device stores resist shape data indicating the predetermined shape to be shaped by the laser irradiating device, and based on the resist shape data stored, controls the operation of the laser irradiating device so as to shape the resist.

Further, the apparatus comprises a movable table, on which the etching object is mounted, moving along a mounting surface so as to set a position of the etching object when shaping the resist by the laser irradiating device. At this time, the laser irradiating device moves corresponding to the moving operation of the movable table and irradiates the laser beam.

Further, an apparatus for forming an air bearing surface of a magnetic head, which is another aspect of the present invention, is one in which the etching object is a magnetic head, and the apparatus for forming the surface shape according to any one of those described above is provided so as to form the air bearing surface of the magnetic head.

Since either of the apparatus for forming a surface shape or the apparatus for forming an air bearing surface of a magnetic head having the above-described configurations acts in a manner similar to that of the above-described method of forming a surface shape, the object of the present invention can be achieved. As described above, when a movable table is provided, a laser irradiating operation can be performed effectively, so it is possible to realize resist forming processing rapidly with high accuracy.

### EFFECT OF THE INVENTION

The present invention is configured and works as described above. Therefore, exposure and development processing shown in the conventional example is not required, whereby it is possible to shorten the steps of forming a surface shape and to reduce the manufacturing cost. Further, since a resist is formed with high accuracy, the present invention has such an excellent effect that even a complex surface shape can be formed with high accuracy, which has not been enjoyed conventionally.

### BRIEF DESCRIPTION OF THE DRAWINGS

FIG. 1 is a block diagram showing the configuration of an apparatus for forming an air bearing surface in an embodiment 1;

FIG. 2 is a functional block diagram showing the configuration of a controller in the embodiment 1;

FIGS. 3A to 3D are diagrams showing states of forming the air bearing surface in the embodiment 1, respectively;

FIGS. 4A to 4D are diagrams showing states of forming the air bearing surface in the embodiment 1, respectively, continued from FIG. 3D;

FIG. 5 is a flowchart showing the operation in the embodiment 1;

FIG. 6 is a block diagram showing the configuration of an apparatus for forming an air bearing surface in an embodiment 2;

FIGS. 7A to 7D are diagrams showing states of forming the air bearing surface in the embodiment 2, respectively;

FIGS. 8A to 8D are diagrams showing states of forming the air bearing surface in the embodiment 2, respectively, continued from FIG. 7D;

FIG. 9 is a flowchart showing the operation in the embodiment 2; and

FIG. 10 is a flowchart showing the operation of forming an air bearing surface in a conventional example.

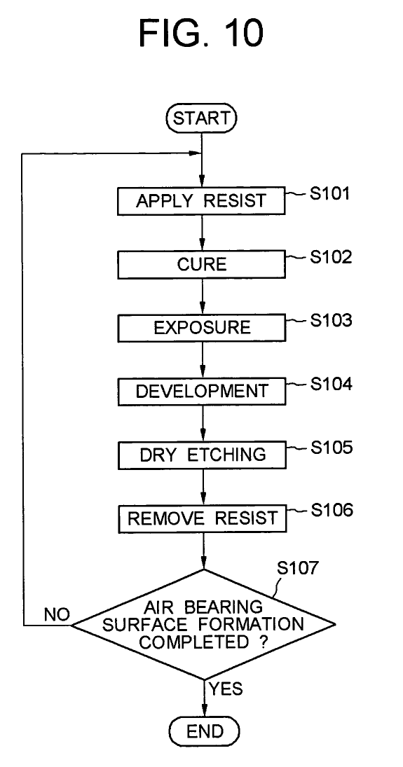

### DESCRIPTION OF PREFERRED EMBODIMENTS

The present invention is characterized in an aspect that a laser beam is irradiated to a part of a resist which has been attached so as to remove the irradiated part to thereby form a resist of a predetermined shape.

Hereinafter, a magnetic head for reading data from a hard disk in a hard disk drive (HDD) will be used particularly as an example of an etching object, and an explanation will be given for a case where a resist is formed in order to perform etching to the air bearing surface (ABS) thereof. Note that a surface formed by using the present invention is not limited to an air bearing surface of a magnetic head, and an etching object serving as the object of forming a surface shape is not limited to a magnetic head.

### Embodiment 1

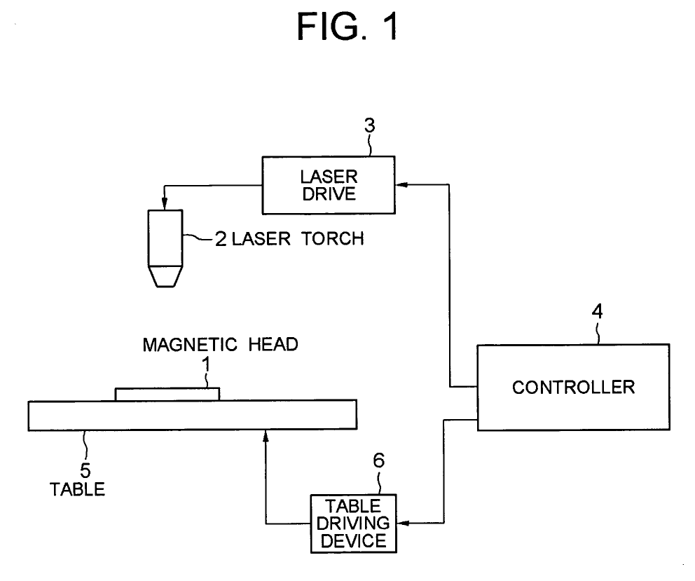

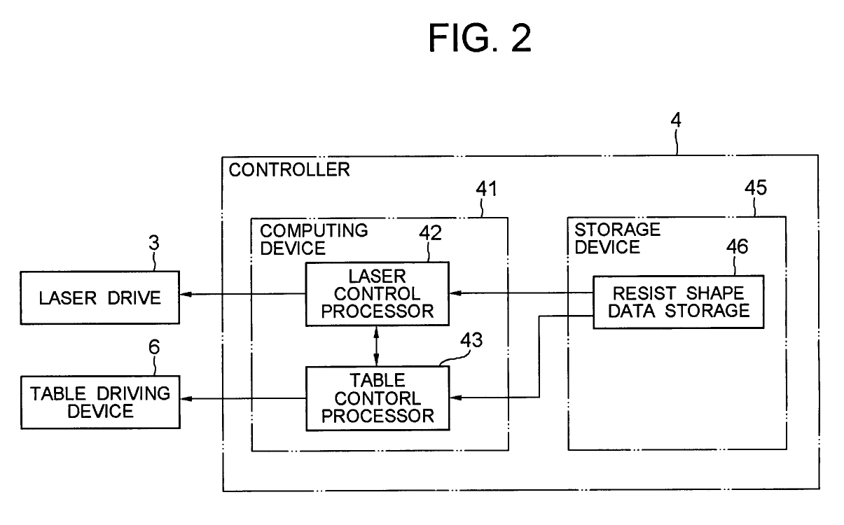

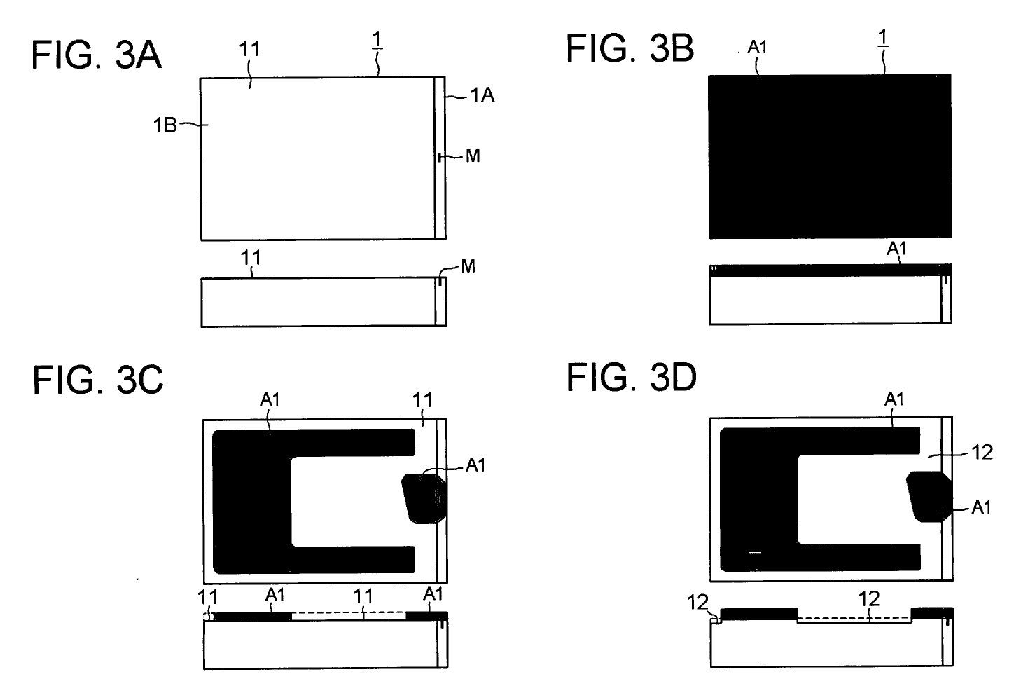

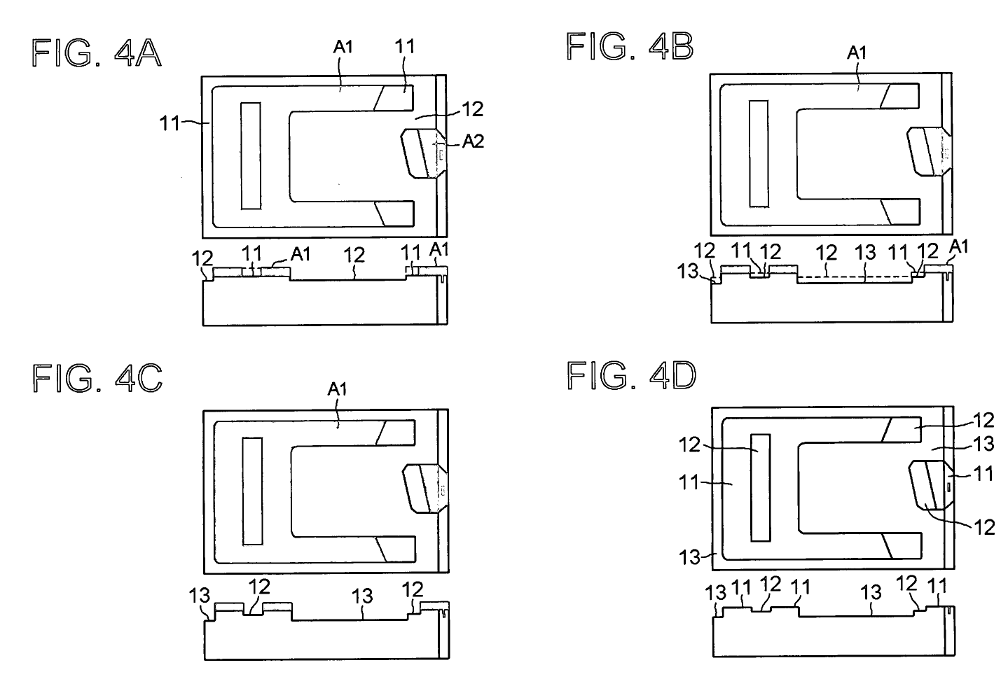

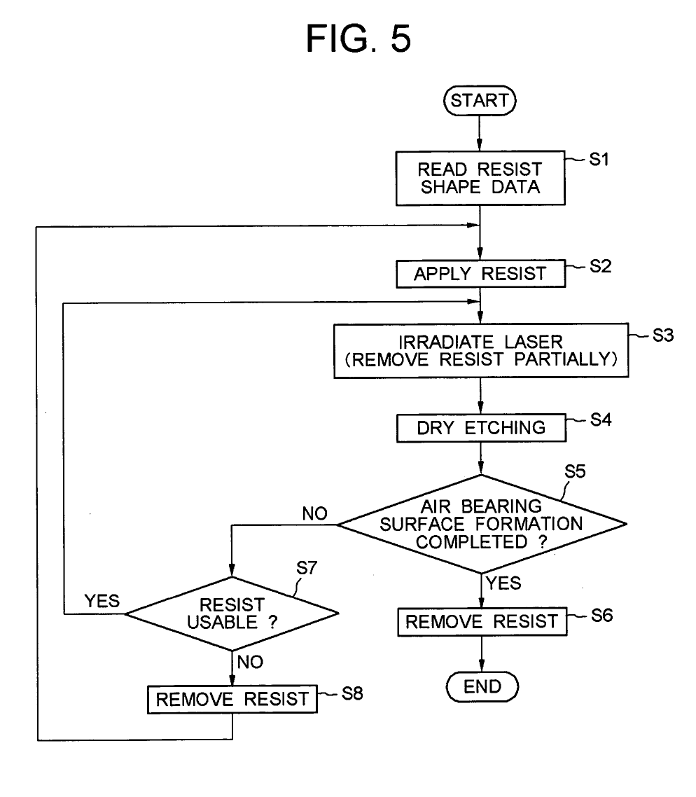

A first embodiment of the present invention will be explained with reference to FIGS. 1 to 5. FIG. 1 is a block diagram showing the configuration of an apparatus for forming an air bearing surface of a magnetic head. FIG. 2 is a functional block diagram showing the configuration of a controller. FIGS. 3A to 4D are explanatory diagrams showing states of forming an air bearing surface of a magnetic head. FIG. 5 is a flowchart showing the operation of the apparatus for forming a surface shape.

[Configuration]

The configuration of an apparatus for forming an air bearing surface (surface shape forming apparatus), which is the present invention, will be explained with reference to FIG. 1. The apparatus for forming an air bearing surface of a magnetic head includes: a resist applying device (resist attaching device (resist forming device)), not shown, for applying a resist material to a magnetic head 1; and laser irradiating devices 2 and 3 (resist forming devices) for irradiating a laser beam to the resist material attached. Further, the apparatus includes: a table 5 (movable table), on which the magnetic head 1 is mounted, moving along the mounting surface so as to set the position of the magnetic head 1; a table driving device 6 for driving the table 5; and a controller 4 (control device) for controlling resist irradiating operation of the laser irradiating device 2. Further, although not shown, a resist removing device for removing all of the resist which has been formed on the magnetic head 1 but is not required any more. Hereinafter, each configuration will be explained in detail.

<Magnetic Head>

The magnetic head 1 is an etching object which is formed in a magnetic head capable of being mounted in a disk drive later. As shown in FIG. 3A, the magnetic head 1 is formed in a rectangle shape with a predetermined thickness, and there is formed a magnetic head element part 1A including a magneto-resistance effect element M for reading data on one end thereof. The other end side is called a magnetic head slider part 1B (main body). On one surface of the magnetic head 1 where the magneto-resistance effect element M is exposed, an air bearing surface (ABS) having irregularities (level differences) of a predetermined shape for realizing a low flying operation with respect to the magnetic disk is formed in such a manner that etching is performed after resist formation and the processing is repeated, as described later. Accordingly, the magnetic head 1 is mounted on the table 5 such that a surface where the magneto-resistance effect element M is exposed (surface denoted by the reference numeral 11) faces upward, and respective steps described later will be performed.

<Table>

The table 5 is for fixedly mounting the magnetic head 1 thereon. The table 5 is supported by the table driving device 6 and moves along the mounting surface (on the X-Y plane). Accordingly, the table is capable of moving the position on the X-Y plane of the magnetic head 1 with respect to a laser torch 2 described later.

The table driving device 6 drives the position of the table 5, controlled by the controller 4 described later when a resist is formed on the magnetic head 1 mounted. At this time, since it moves corresponding to the laser irradiating operation of the laser irradiating devices 2 and 3 described later, it is movable corresponding to the shape of the resist to be shaped. For example, it is movable at a speed of not less than 10 mm/sec, and it is desirable to have a positioning accuracy of not more than 2 μm.

<Resist Applying Device>

Although not shown, the resist applying device is a device for applying and attaching a resist material of a thin film on a surface serving as an air bearing surface of the magnetic head 1. The applying method is, for example, to drop a resist in a liquid state to a predetermined surface of the magnetic head 1 mounted on a rotational support, not shown, which is rotated at a high speed whereby the resist is applied in a thin film shape. Then, as shown in FIG. 3B for example, the resist, in a thin film shape, is applied all over the air bearing surface of the magnetic head 1. Note that the resist applying device may be a device capable of applying a resist in a state where the magnetic head 1 is mounted on the table 5.

Here, as a resist material to be applied, one having resistance to etching and capable of being thermally decomposed by being heated with laser irradiation as described above is used. For example, it is formed of polymeric material including C, H and N. More specifically, styrene resin having EL (ethyl lactate) as a solvent and styrene resin having PGMEA (propylene glycol monomethyl ethyl acetate) as a solvent are usable. However, the resist material is not limited to those described above.

Here, the resist applying device is not limited to attaching a resist material on the surface of the magnetic head 1 by applying it as described above. For example, a tape-shaped resist material may be attached to the magnetic head 1. Alternatively, a resist material may be attached by any other method. Further, it is not limited to a method that a resist material is attached over the whole surface of the magnetic head 1 as shown in FIG. 3B. A resist material may be attached to a range which contains at least the whole or a part of a resist shape to be formed. Further, only a part of the resist shape may be shaped by the laser irradiating devices 2 and 3 described later.

<Laser Irradiating Devices>

As shown in FIG. 1, the laser irradiating devices 2 and 3 specifically consist of a laser torch 2 for irradiating a laser beam, and a laser drive 3 which supports the laser torch 2, controls the laser irradiating operation and controls the movement of the laser torch 2 so as to set a laser irradiating position.

The laser torch 2 is, for example, one outputting a maxima laser which is irradiated to a resist having been applied on the magnetic head 1 so as to heat a part of the resist and thermally decompose and remove it. For example, the resist may be removed by such an action that the resist is sublimated by being heated. Note that processing of removing a part of the resist by using a laser beam is not limited to be performed by the action described above, and it may be removed by another principle using the irradiation energy of the laser beam.

Further, the laser torch 2 is drive-controlled by the laser drive 3 supporting it, and is movable in an X-Y direction at a speed of not less than 0.1 mm/sec and has a positioning accuracy of not more than 2 μm, for example. Then, according to a control instruction from the controller 4, the laser drive 3 moves the laser torch 2 and controls irradiation of a laser beam so as to shape the resist into a predetermined shape.

<Controller>

The controller 4 includes a computing device 41 such as a CPU, and a storage device 45 such as a ROM which is rewritable and capable of saving stored data. In the storage device 45, there is formed a resist shape data memory 46 for storing resist shape data to be plotted on the magnetic head 1 by the laser torch 2. The resist shape data is registered by an operator beforehand, including data of a different shape for each stage (each cycle) of etching performed to the air bearing surface of the magnetic head 1. For example, in order to form an air bearing surface of the shapes shown in FIGS. 3A to 4D, shapes (shaded shapes) shown in FIGS. 3B and 4A are formed respectively before etching as described later, so such two patterns of resist shape data are stored separately for each stage (cycle).

In the computing device 41, with a predetermined program being incorporated beforehand, a laser control processor 42 for controlling the operation of the laser torch 2 and a table control processor 43 for controlling the operation of the table 5 are constructed. The laser control processor 42 reads out resist shape data to be formed in the current step from the resist shape data memory 46, and transmits an instruction to the laser drive 3 so as to form a resist of such a shape on the air bearing surface of the magnetic head 1 mounted on the table 5. Thereby, the laser torch 2 irradiates a laser beam while moving in X, Y and Z directions so as to remove an unnecessary part by thermal decomposition to thereby shape the applied resist into the instructed shape. At this time, the table control processor 43 works in cooperation with the inkjet control processor 42 to drive the table driving device so as to move the position of the mounted magnetic head 1 on the X-Y plane in order to enable to shape the predetermined resist shape by the laser torch 2. Thereby, the movement of the laser torch 2 can also be suppressed to the minimum, whereby the shaping processing of the resist shape can be performed rapidly with high accuracy. Further, since the driving amount of the laser torch 2 can be suppressed, mechanical exhaustion thereof can be suppressed.

Note that in the present embodiment, a resist shape shaped by irradiation performed by the laser torch 2 may be shaped by removing a part of a resist newly applied as described above, or may be formed by removing a part of the resist to which etching has been performed once. That is, first, in the first cycle, a resist is attached by a resist applying device (not shown), and the resist is shaped by removing, and etching is performed thereto. Then, in the second circle, the resist used in the etching of the first cycle is used as it is, and a part of it is removed and shaped by the laser, and etching is performed. Thereby, etching of the second cycle is performed.

Further, although explanation will be only given for etching of the second cycle below, in a case where etching is further performed and if it is possible to form a resist shape usable in the following etching by removing a part of the resist having been formed, a resist formation by irradiating a laser beam may be repeated in the same manner as described above.

<Other Configurations>

Next, an etching device, not shown, will be explained. As described above, the etching device is a device for performing etching, with respect to the magnetic head 1 on which the resist has been formed as described above, to a part where the resist has not been formed. For example, the etching device irradiates an ion beam to the magnetic head 1 so as to perform dry etching such as ion beam etching. Note that the etching device may perform etching by any other method.

Further, a resist removing device, also not shown, is formed in the magnetic head 1 as described above, and removes all parts of the resist not required any more. For example, resist is removed after etching of each stage (each cycle) is completed but before a resist formation of the next step is performed. Alternatively, the resist is removed when all etching has been completed.

[Operation]

Next, the operation of a method of forming an air bearing surface (method of forming a surface shape) by using the above-described apparatus for forming an air bearing surface of a magnetic head will be explained with reference to FIGS. 3A to 5. FIGS. 3A to 4D show states of an air bearing surface by respective steps for forming an air bearing surface shape having irregularities on the air bearing surface of the magnetic head 1. In each Figure, a plan view of the air bearing surface of the magnetic head 1 in each stage is shown in the upper part, and a central sectional view thereof is shown in the lower part. Further, FIG. 5 is a flowchart showing the operation of the apparatus of forming an air bearing surface of a magnetic head at that time.

First, the laser control processor 42 and the table control processor 43 of the controller 4 read out resist shape data from the resist shape data memory 46 (step S1). Then, around the readout processing, a resist is applied on the air bearing surface of the magnetic head 1 by the resist applying device not shown (step S2, resist applying step (resist forming step)). For example, in the first cycle, on the flat air bearing surface (denoted by the reference numeral 11) of the magnetic head 1 shown in FIG. 3A, a resist is applied all over the surface (shown by the shaded part in FIG. 3B).

Next, to the air bearing surface of the magnetic head 1 to which the resist A1 is applied, a laser is irradiated by the laser torch 2 so as to remove an unnecessary part (step S3, shaping step (resist forming step)). More specifically, based on the resist shape of the first cycle included in the resist shape data read out from the resist shape data memory 46, the laser torch 2 and the table 5 are moved, and a laser beam is irradiated from the laser torch 2 so as to remove a part of the resist A1 to form a predetermined shape, whereby a shape capable of being etched is shaped. For example, by removing a part from the resist shape A1 shown in FIG. 3B, a resist A1 of the shape shown in FIG. 3C is formed. Note that the dotted part shown in the sectional view of FIG. 3C is a part where the resist is removed by the laser beam.

Then, to the air bearing surface of the magnetic head 1 on which the resist A1 of the shape shown in FIG. 3D is formed, dry etching is performed by an etching device (not shown) (step S4, etching step). With this step, as shown in FIG. 3D, the part where the resist A1 is not formed is eroded by a predetermined height. Note that the shape indicated by the dotted line in FIG. 3D shows the position of the air bearing surface before etching. Thereby, on the plane of the height denoted by the reference numeral 11 before etching, a lower level denoted by the reference numeral 12 is formed, and etching of the first cycle ends.

Next, in order to form a second level difference, etching of the second cycle is performed (negative determination in step S5). Here, in the present embodiment, it is assumed that the shape of the resist used in the second cycle can be shaped by removing a part of the resist formed in the first cycle shown in FIG. 3D. That is, the resist formed in the first cycle is usable (positive determination in step S7). Accordingly, with respect to the resist, laser irradiation is performed based on the resist shape data of the second cycle so as to remove a part of the resist, whereby the resist is shaped into the resist shape of the second cycle (step S3, shaping step). Note that if the resist of the previous cycle cannot be used (negative determination is step S7), all of the resist used in the previous cycle is removed (step S8), and a new resist is applied by the resist applying device again (step S3), and a laser beam is irradiated so as to shape the resist shape of the second cycle (step S3). Thereby, in the present embodiment, the resist is shaped into one shown in FIG. 4A. Note that the part indicated by the dotted line shown in the sectional view of FIG. 4A is a part where the resist is removed by the laser beam.

Then, dry etching is performed by an etching device (not shown) to the air bearing surface of the magnetic head 1 in a state where the resist A1 of the shape shown in FIG. 4B is formed (step S4, etching step). With this step, as shown in FIG. 4C, the part where the resist A1 is not formed is eroded by a predetermined height. Note that the shape indicated by the dotted line in FIG. 4C shows a position of the air bearing surface before etching. Thereby, on the plane of the height denoted by the reference numeral 11 before etching, a low level denoted by the reference numeral 12 is formed, and on the plane of the height denoted by the reference numeral 12 before etching, a lower level denoted by the reference numeral 13 is formed, whereby the air bearing surface having two stages of level difference is formed. Note that the height shown by the reference numeral 12 formed in the second cycle and the height shown by the reference numeral 12 formed in the first cycle are not limited to be the same height. For example, they may differ depending on the etching time in each cycle or the like. With this step, etching of the second cycle ends.

With this step, etching in the present embodiment ends, so the irregularities of the air bearing surface which has been planned are completed. Accordingly, the resist A1 formed on the magnetic head 1 is removed by a resist removing device (not shown) (step S6, resist removing step), and formation of the air bearing surface is completed as shown in FIG. 4D.

In this way, by irradiating a laser beam while performing the positioning thereof with high accuracy, it is possible to form a resist in a desired shape with high accuracy, whereby the shape of the air bearing surface of the magnetic head can be formed with high accuracy by etching. In particular, a new resist shape can be formed by removing a part of the resist having been used, whereby the resist can be utilized effectively, so it is possible to reduce the etching cost and to reduce the processing time.

Although a case of forming an air bearing surface shape in two stages by two-cycle etching has been exemplary described in the above, etching may be performed further for forming more level differences. That is, in step S5 in FIG. 5, negative determination may be done so as to repeat steps S3 and S4.

Note that as the resist applying device described above, a resist discharging device such as an inkjet device or a bubble jet device for forming a resist shape by discharging a resist material to the magnetic head 1 may be used. By controlling the discharging operation of the resist discharging device by the controller 4, based on the resist shape stored on the resist shape data memory 46, the resist may be formed to be plotted to have a shape slightly larger than the shape. Thereby, the amount of resist to be removed thereafter by laser irradiation can be reduced, so it is possible to speed up shaping of a resist shape by the laser. Further, if a part of the resist plotting performed by the resist discharging device overlaps the resist shape to be formed, there is no need to perform shaping by the laser to such a part. In such a case, shaping of the resist shape may be performed by removing only a part of the plotted resist stuck out from the shape to be formed with laser irradiation instead.

### Embodiment 2

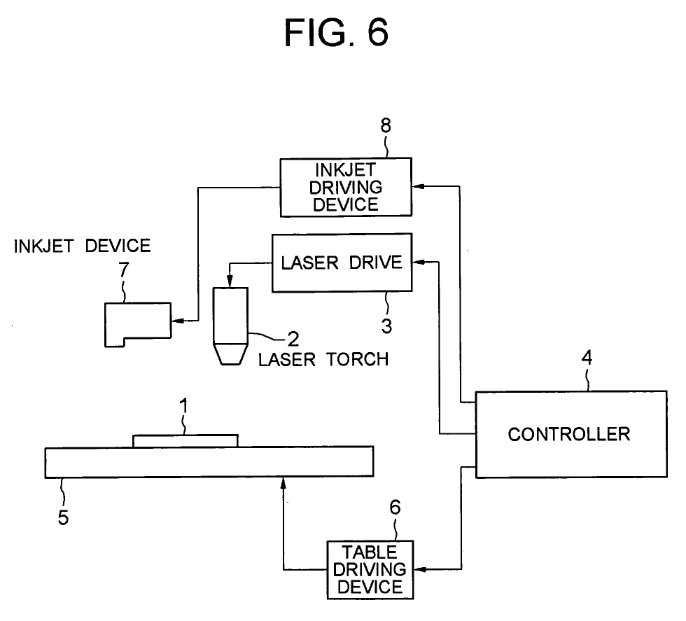

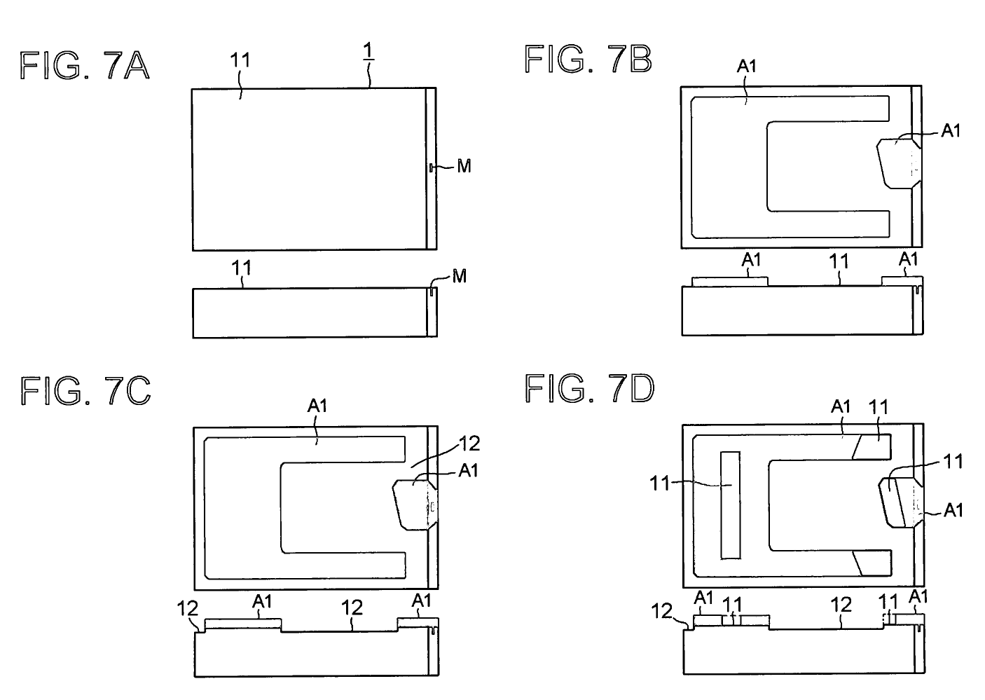

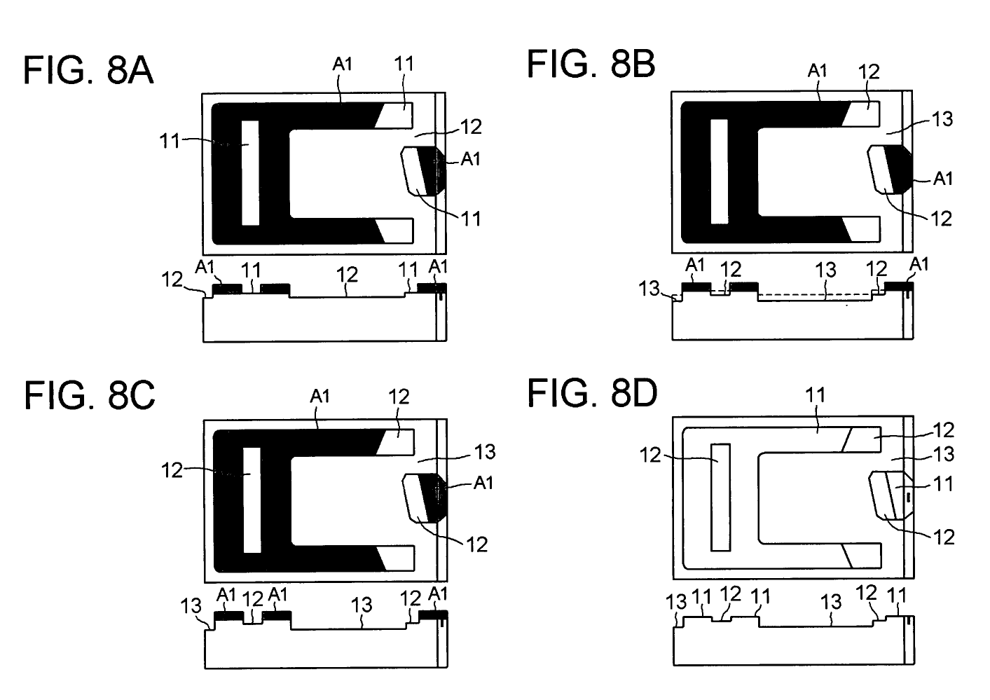

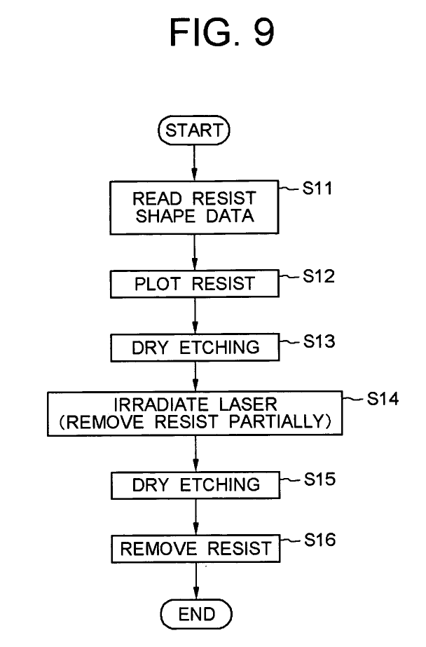

Next, a second embodiment of the present invention will be explained with reference to FIGS. 6 to 9. FIG. 6 is a block diagram showing the configuration of an apparatus for forming an air bearing surface of a magnetic head. FIGS. 7A to 8D are explanatory diagrams showing states of forming an air bearing surface of a magnetic head. FIG. 9 is a flowchart showing the operation of the apparatus for forming an air bearing surface.

[Configuration]

An apparatus for forming an air bearing surface of a magnetic head in the present embodiment includes, in addition to the configurations explained in the embodiment 1, an inkjet device 7 (resist forming device) for discharging a resist material so as to form a resist of a predetermined shape on the magnetic head 1, and an inkjet driving device 8 for driving and positioning the inkjet device 7, which are configured to be used together with the laser irradiating devices 2 and 3 when forming a resist.

The inkjet device 7 is a device for discharging a resist material by an inkjet system. The inkjet device 7 is supported by the inkjet driving device 8, and discharges the resist material corresponding to a control instruction from the controller 4. At this time, since it is controlled based on resist shape data which has been defined in the controller 4 as described later, the inkjet device 7 is controlled to move to a position where a resist is plotted to be in such a shape, and discharge of the resist material is controlled.

Further, corresponding to the operation of the inkjet device 7, the operation of the table 5 is also controlled by the controller 4 as described above. That is, with the inkjet device 7 and the table 5 being operated in cooperation, it is possible to rapidly move the inkjet device 7 to the position based on the resist shape data with respect to the resist forming location of the magnetic head 1, whereby resist plotting can be performed rapidly with high accuracy.

The inkjet device 7 is movable at a speed of not less than 0.1 mm/sec, and it is desirable to have a positioning accuracy of not more than 2 μm. Further, it is desirable that a discharge cycle of the resist material be not less than 10 kHz, and that the discharge amount of one time (one drop) be not more than 2 pl (picoliter). More desirably, the discharge amount should be not more than 0.5 pl (picoliter). In the present embodiment, the resist material to be discharged is preferably prepared by using a material having resistance to dry etching performed by an etching device described later and capable of being discharged in fine droplets as described above. For example, styrene resin having EL (ethyl lactate) of small molecular weight as a solvent is desirable. Alternatively, styrene resin having PGMEA (propylene glycol monomethyl ethyl acetate) as a solvent is also usable. However, the resist material is not limited to those described above.

In this way, by plotting a resist by discharging the resist material by the inkjet device 7, the thickness of the resist can be 3 to 6 μm, which is much thinner comparing with the conventional case of forming a resist by performing exposure and development where the thickness is 10 to 20 μm. Thereby, it is possible to form the wall of the dented part steeply through etching.

Although, in the present embodiment, a case in which the resist material is discharged to the magnetic head 1 by the inkjet device 7 is exemplary described, a discharging method is not limited to this. Instead of the inkjet device 7, a device for discharging the resist material by a bubble jet system may be used for forming a resist. Further, the present invention is not limited to the method described above, and a device capable of plotting a resist by discharging the resist material in another structure may be used.

Along with it, in the computing device 41 of the controller 4 in the present embodiment, an inkjet control processor (not shown) for controlling the operation of the inkjet device 7 is constructed with a predetermined program being incorporated beforehand. The inkjet control processor reads out resist shape data to be formed in the current step from the resist shape data memory 46, and transmits an instruction to the inkjet driving device 8 so as to form a resist of such a shape on the air bearing surface of the magnetic head 1 mounted on the table 5. Thereby, the inkjet device 7 discharges the resist material while moving in X, Y and Z directions so as to plot a resist of the instructed shape. Further, a table control processor 43 works in cooperation with the inkjet control processor to move the position of the mounted magnetic head 1 on the X-Y plane so as to enable plotting of the predetermined resist shape by the inkjet device 7. Thereby, movement of the inkjet device 7 can be suppressed to the minimum, and the plotting processing can be performed rapidly, and mechanical exhaustion of the inkjet device 7 caused by driving the inkjet device 7 can be suppressed.

[Operation]

Next, the operation of a method of forming an air bearing surface (method of forming a surface shape) by using the apparatus for forming an air bearing surface of a magnetic head in the present embodiment will be explained with reference to FIGS. 7A to 8D. FIGS. 7A to 8D show states of an air bearing surface by respective steps of forming an air bearing surface shape having irregularities on the air bearing surface of the magnetic head 1. In each Figure, a plan view of the air bearing surface of the magnetic head 1 in each stage is shown in the upper part, and a central sectional view thereof is shown in the lower part. Further, FIG. 9 is a flowchart showing the operation of the apparatus for forming an air bearing surface of a magnetic head at that time.

First, the controller 4 reads out resist shape data from the resist shape data memory 46 (step S11), and based on the data, moves the inkjet device 7 and the table 5, and plots a resist in a predetermined shape by discharging the resist material A from the inkjet device 7 (step S12, resist forming step). For example, in the first cycle, a resist A1 of the shape shown by the shaded part in FIG. 7B is formed on the flat air bearing surface (denoted by the reference numeral 11) of the magnetic head 1 shown in FIG. 7A.

Next, to the air bearing surface of the magnetic head 1 on which the resist A1 is formed, dry etching is performed by an etching device (not shown) (step S13, etching step). With this step, as shown in FIG. 7C, the part where the resist A1 is not formed is eroded by a predetermined height, whereby a low level (dented part) denoted by the reference numeral 12 is formed. Thereby, the air bearing surface is in a stepped shape (dented shape) such that the part denoted by the reference numeral 11 of the air bearing surface is the highest and the part denoted by the reference numeral 12 is low. In this way, the first cycle ends.

Next, resist formation of the second cycle in the present embodiment is performed by irradiating a laser by the laser torch 2 to the resist A1 having been plotted and formed by the inkjet device 7 as described above so as to remove the unnecessary part (step S14, shaping step). More specifically, based on the resist shape of the second cycle included in the resist shape data read out from the resist shape data memory 46, the laser torch 2 and the table 5 are moved, and a laser beam is irradiated from the laser torch 2 so as to remove a part of the resist A1 to thereby form a predetermined shape. For example, by removing a part from the resist shape A1 shown in FIG. 7C, the resist A1 of the shape shown in FIG. 7D is formed. Note that a part indicated by the dotted line shown in the sectional view in FIG. 7D is a part where the resist is removed by the laser beam.

Then, dry etching is performed by an etching device (not shown) to the air bearing surface of the magnetic head 1 in a state where the resist A1 of the shape shown in FIG. 8A is formed (step S15, etching step). With this step, as shown in FIGS. 8B and 8C, a part where the resist A1 is not formed is eroded by a predetermined height. Note that the shape indicated by the dotted line in FIG. 8B shows the position of the air bearing surface before etching. Thereby, on the plane of the height denoted by the reference numeral 11 before etching, a low level denoted by the reference numeral 12 is formed, and on the plane of the height denoted by the reference numeral 12 before etching, a lower level denoted by the reference numeral 13 is formed, whereby the air bearing surface having two stages of level difference is formed. Note that the height shown by the reference numeral 12 formed in the second cycle and the height shown by the reference numeral 12 formed in the first cycle are not limited to be the same height. For example, they may differ depending on the etching time in each cycle or the like.

Then, the resist A1 formed on the magnetic head 1 is removed by a resist removing device (not shown) (step S16, resist removing step), and formation of the air bearing surface is completed as shown in FIG. 8D.

In this way, it is possible to plot a resist with high accuracy by the inkjet device 7, and with such a method, it is possible to form a resist rapidly at lower cost comparing with the conventional case, and to form an air bearing surface with high accuracy. Then, since a new resist shape can be formed by removing a part of the resist having been plotted, the resist can be utilized effectively, so it is possible to reduce the etching cost and to reduce the processing time. At this time, since shaping of the resist is performed with a laser beam having high positioning accuracy, resist formation can be performed with high accuracy, so the shape of the air bearing surface of the magnetic head can be formed with high accuracy by etching, as described above.

Although a case of forming an air bearing surface shape in two stages by two-cycle etching has been exemplary described in the above, etching may be performed further for forming more level differences. In such a case, if it is possible to form a new resist by removing a part of the resist shape shown in FIG. 8C, a laser beam may be irradiated to the resist in the same manner as described above to thereby form a new resist. In other words, following step S15 in FIG. 9, step S14 and step S15 may be performed once more or repeated for plural times. On the other hand, if the resist having been used in the previous etching step cannot be used in the next step, after removing the resist (step S16), plotting of a resist may be performed further (step S12) and etching with respect to the resist may be performed (step S13).

### INDUSTRIAL AVAILABILITY

An apparatus for forming a surface shape which is the present invention can be used in a case of forming an air bearing surface of a magnetic head for example, and has an industrial availability.

1. A method of forming a surface shape, comprising:
forming a resist of a predetermined shape on a predetermined surface of an etching object; and
etching the predetermined surface of the etching object on which the resist is formed;
wherein forming the resist comprises attaching a resist material to the predetermined surface of the etching object; and shaping the attached resist material into the predetermined shape by irradiating the attached resist material with a laser beam to remove a part of the resist material.

2. The method of forming the surface shape as claimed in claim 1, wherein the part of the resist material is thermally decomposed and removed by the laser beam.

3. The method of forming the surface shape as claimed in claim 1, wherein in the part of the resist material is sublimated and removed by the laser beam.

4. The method of forming the surface shape as claimed in claim 1, wherein the resist material has resistance to etching and is capable of being thermally decomposed or sublimated.

5. The method of forming the surface shape as claimed in claim 1, further comprising, after etching the predetermined surface, repeating the shaping and the etching of the predetermined surface of the etching object.

6. The method of forming the surface shape as claimed in claim 5, further comprising forming the resist of another predetermined shape before repeating shaping of the attached resist material.

7. The method of forming the surface shape as claimed in claim 1, wherein the resist material is attached to the predetermined surface of the etching object by being discharged thereto.

8. The method of forming the surface shape as claimed in claim 7, wherein the resist material is discharged by an inkjet system or a bubble jet system.

9. A method of forming an air bearing surface of a magnetic head, wherein
the etching object is a magnetic head, and
the air bearing surface of the magnetic head is formed by using the method of forming the surface shape as claimed in claim 1.

10. An apparatus for forming a surface shape comprising:
a resist forming device for forming a resist of a predetermined shape on a predetermined surface of a etching object; and
an etching device for performing etching to the predetermined surface of the etching object on which the resist is formed, wherein
the resist forming device includes: a resist attaching device for attaching a resist material to the predetermined surface of the etching object; and a laser irradiating device for irradiating a laser beam to the resist material attached so as to remove a part of the resist material to thereby shape the resist material into the predetermined shape.

11. The apparatus for forming the surface shape as claimed in claim 10, wherein the laser irradiating device thermally decomposes and removes the resist material by the laser beam.

12. The apparatus for forming the surface shape as claimed in claim 10, wherein the laser irradiating device sublimates and removes the resist material by the laser beam.

13. The apparatus for forming the surface shape as claimed in claim 11, wherein the resists material to be attached to the etching object by the resist attaching device is a material having resistance to etching and capable of being thermally decomposed or sublimated.

14. The apparatus for forming the surface shape as claimed in claim 10, further comprising, a control device for controlling an operation of the laser irradiating device, wherein,
the control device stores resist shape data indicating the predetermined shape to be shaped by the laser irradiating device, and based on the resist shape data stored, controls the operation of the laser irradiating device so as to shape the resist.

15. The apparatus for forming the surface shape as claimed in claim 10, further comprising a movable table on which the etching object is mounted, moving along a mounting surface so as to set a position of the etching object when shaping the resist by the laser irradiating device.

16. The apparatus for forming the surface shape as claimed in claim 15, wherein the laser irradiating device moves in correspondence with a moving operation of the movable table and irradiates the laser beam.

17. An apparatus for forming an air bearing surface of a magnetic head, wherein
the etching object is a magnetic head, and
the apparatus for forming the surface shape according to claim 10 is provided so as to form the air bearing surface of the magnetic head.
